(19) United States
(12) Patent Application Publication
(10) Pub. No.: US 2012/0244891 A1
(43) Pub. Date: Sep. 27, 2012

(54) SYSTEM AND METHOD FOR ENABLING A MOBILE CHAT SESSION

(76) Inventor: Andrew B. Appleton, Prairie Village, KS (US)

(21) Appl. No.: 13/421,481

(22) Filed: Mar. 15, 2012

Related U.S. Application Data
(60) Provisional application No. 61/454,750, filed on Mar. 21, 2011.

(51) Int. Cl. H04W 4/12

(52) U.S. Cl. 455/466

(57) ABSTRACT

Methods and systems for facilitating communication between a telecommunication device and a third party are disclosed. A telecommunication device sends a communication request to a server that includes image data associated with a product or s service. The server processes the image data to identify a location of a third party computing device for the product or service on a communication network. The server transfers the communication request top the third party computing device. The third party computing device then initiates a communication session with the telecommunication device.

### RELATED APPLICATIONS

This application is based on and claims priority to U.S. Provisional Application Ser. No. 61/454,750 filed Mar. 21, 2011, the entire contents of which is herein incorporated by reference.

### FIELD OF THE INVENTION

Aspects of the present invention relate to systems and methods for enabling telecommunication devices to initiate communication sessions with third party computing devices using image data captured on a mobile telecommunication device.

### BACKGROUND

The use of mobile devices in various types of mobile consumer transactions and commerce related communications is becoming more common and more complex. As a result, many mobile device users may have a wide range of customer service needs.

Typically, users of mobile devices resort to traditional customer service features such as calling customer help-lines or viewing customer support Internet websites to handle customer service needs. While some mobile devices may have access to the Internet, using these traditional methods of customer support may result in long wait times and other inconveniences.

In recent years, many mobile devices such as cell phones, smart phones, and Personal Digital Assistants (PDAs) have been designed with built-in cameras that provide the ability to capture and decode barcodes. Barcodes are a compact form of holding information. Commonly used barcodes include two-dimensional barcodes (2D) such as Quick Response (QR) codes.

Mobile devices with the ability to capture and read barcodes may be used to provide new, more efficient, customer service opportunities to mobile device users.

### SUMMARY

A system is provided for initiating a communication session between a telecommunication device and a server. The system includes a mobile chat application executable by the server to receive image data from the telecommunication device. The mobile chat application processes the received image data to extract identification data. The identification data identifies a product and/or service associated with the telecommunication device and a location of a customer service third party computing device on a communication network. The mobile chat application also generates a communication request to transmit to the customer service third party computing device at the identified location. The mobile chat application also receives a communication response from the third party computing device. The communication response includes chat data in a first format. The mobile chat application further converts the chat data from the first format to a second format and transmit the chat data in the second format to the telecommunication device.

In another aspect, a method is provided for enabling mobile chat between a telecommunication device and a third party computing device. The method includes receiving an image at a server from the telecommunication device. The method further includes processing the image at the server to extract identification data. The identification data identifies a product associated with the telecommunication device, and a location of a customer service third party computing device on a communication network. The method includes generating a communication request to transmit to the customer service third party computing device. The method further includes receiving a communication response from the third party computing device. The communication response includes chat data in a first format. The method provides converting the chat data from the first format to a second format and transmitting the chat data in the second format to the telecommunication device.

### BRIEF DESCRIPTION OF THE DRAWINGS

FIG. 1 is a block diagram of a mobile chat system for enabling a communication session between a telecommunication device and a third party computing device.

FIG. 2A is a block diagram of a mobile chat application.

FIG. 2B is a screen shot of an image application selection screen according to one aspect of the mobile chat system.

FIG. 2C is a screen shot of an image capture screen according to one aspect of the mobile chat system.

FIG. 2D is a screen shot of a chat input form screen according to one aspect of the mobile chat system.

FIG. 2E is a screen shot of a chat screen according to one aspect of the mobile chat system.

FIG. 2F is a screen shot of a chat history form according to one aspect of the mobile chat system.

FIG. 2G is a screen shot of another chat session screen according to one aspect of the mobile chat system.

FIG. 3 is a block diagram of a server.

FIG. 4 is a flow chart illustrating a method for capturing image data.

FIG. 5 is a flow chart illustrating initiating a chat from a telecommunication device to a third party computing device according to one aspect of the mobile chat system.

### DETAILED DESCRIPTION

Aspects of the present invention describe methods and systems for initiating a communication session between a telecommunication device and a third party computing device based on a captured image. For example, the telecommunication device may be used to capture an image associated with a product or service. The captured image is processed to identify image data that is used to initiate a communication session, such as mobile chat, with a third party computing device such as a service computer used by a customer service representative and/or product marketing representative for the particular product or service.

Other aspects of the mobile chat system include a server or platform for interfacing the communication session between the telecommunication device and the third party computing device. For example, the server converts data received from the telecommunication device into a format compatible for communicating with the third party computing device and converts data received from third party computing device to a different format compatible for communicating with the telecommunication device.

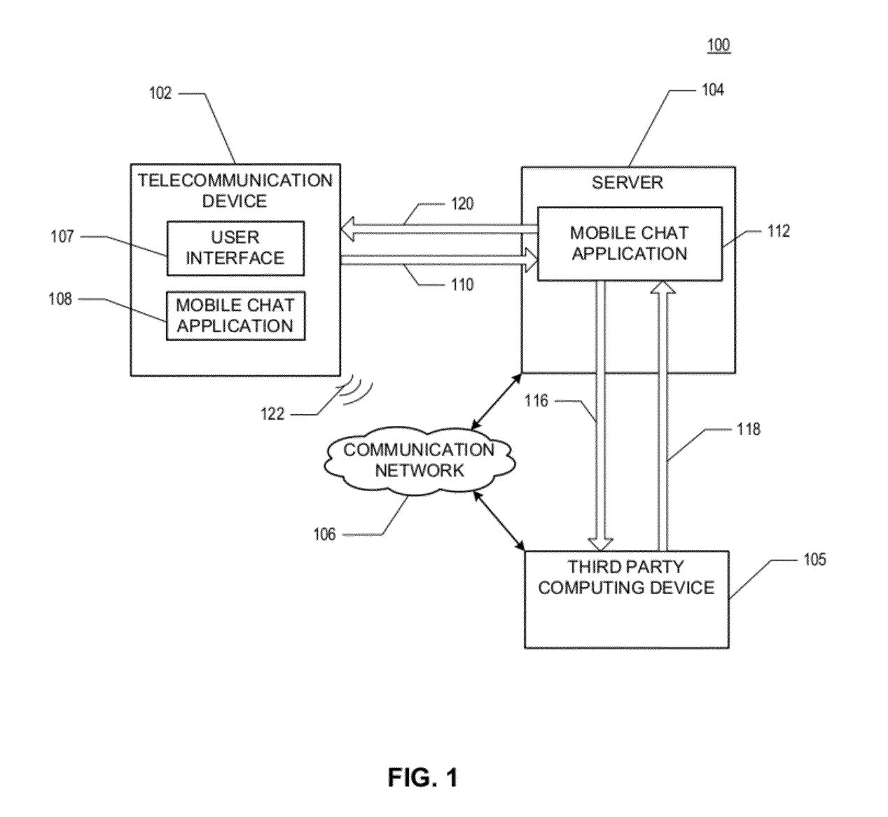

FIG. 1 is a block diagram of a mobile chat system 100 for enabling a mobile chat session between a telecommunication device and a third party computing device. In this instance, FIG. 1 illustrates a cross network communication between a telecommunication device 102, a server 104, and a third party computing device 105.

According to one aspect, each computing device depicted in FIG. 1 (e.g. the telecommunication device 102, the server 104, and the third party computing device 105) is a computer or a processing device, such as a mobile processing device, a personal computer, or a server computer. Each computing device includes one or more processors that process software or other machine-readable instructions and includes a memory to store the software or other machine-readable instructions and data. The memory may include volatile and/or non-volatile memory.

The telecommunication device 102 may communicate with the server 104 and the server 104 may communicate with the third party computing device 105 via a communication network 106. The communication network 106 may be the Internet, an intranet, a local area network, a wireless local network, wide area network, or another communication network. The telecommunication device 102 and the server 104 may communicate using a Wireless Application Protocol, which is a protocol commonly used to provide Internet service to digital mobile phones and other wireless terminals. As another example, the server 104 and the third party computing device 105 may communicate using a hypertext transfer protocol (http), which is a protocol commonly used on the Internet to exchange information between clients and servers.

Although FIG. 1 depicts the telecommunication device 102 communicating with the server 104 and the server 104 communicating with the third party computing device 105 via the same communication network, it is contemplated that two different communication networks can be used. For example, the telecommunication device 102 may communicate with the server 104 via the Internet and the server 104 may communicate with the third party computing device via an intranet.

The telecommunication device 102 includes a user interface 107 that includes a display (not shown), such as a screen for viewing image data, textual data, multimedia data, or any other type of displayable data. The user interface 107 also includes an input device, such as a keypad or a pointing device for inputting or capturing image data and/or mobile chat data.

The telecommunication device 102 includes a mobile chat application 108. The mobile chat application 108 may be downloaded from the server 104 and is a client side implementation of the mobile chat application 112 executed by the server 104. The user interacts with the user interface 107 of the telecommunication device 102 to execute the mobile chat application 108 to capture an image of an object or a symbol that is associated with a particular product or service. For example, the user interacts with the user interface 107 to operate or activate a camera feature available on the telecommunication device to capture an image (e.g., photo, video, or snapshot) of the object or symbol. As another example, the user may download a digital image of the object or symbol to the telecommunication device 102 via the Internet.

According to one aspect, the captured image is a quick response (QR) code. A QR code is a specific matrix barcode, or a two-dimensional code (2D), readable by dedicated QR code readers and camera phones. The code consists of black modules arranged in a square pattern on a white background. The coded information can represent text, a uniform resource locator (URL) or other data. In another aspect, the captured image may be any type of image or symbol capable of embedding or encoding information, or capable of being associated with a particular product or service.

After the user captures an image of the object or symbol, the user interacts with the user interface 107 of the telecommunication device 102 to generate a communication request 110. The communication request 110 is provided to the server 104 via a wireless communication signal, as indicated by reference character 122.

The generated communication request 110 includes image data. The image data includes, for example, the captured image and identification data that is embedded or encoded into the captured image. Identification data includes, for example, text data, image metadata, audio data, multimedia data, or any type of data capable of identifying a particular product or service. The identification data further includes location data that identifies a location for a third party computing device on the communication network (e.g., URL) for conducting a communication session about the product or service.

According to another aspect, the communication request 110 also includes telecommunication device data, such as a phone number, unique device identification data, or other data capable of identifying a particular telecommunication device.

The server 104 executes a mobile chat application 112 in response to the communication request 110 received from the telecommunication device 102 to facilitate the communication session (e.g., a mobile chat) between the telecommunication device 102 and the third party computing device 105. In one aspect, the mobile chat application 112 serves as a communication interface between the telecommunication device 102 and the third party computing device 105. After receiving the communication request 110 from the telecommunication device 102, the mobile chat application 112 extracts the identification data from the image data in the communication request 110 to identify a particular third party computing device for a mobile chat session with the telecommunication device 102. The mobile chat application 112 then forwards the communication request, as indicated by reference character 116, to third party computing device 105 at the identified location.

The mobile chat application 112 receives a communication response 118 from the third party computing device 105 in response to the forwarded reference character 116. As explained in more detail below, the communication response 118 may include third party chat communication data, such as text, images, video, or any other communication data that can be exchanged during a chat session.

Although FIG. 1 illustrates a single telecommunication device 102 communicating with the server 104, it is contemplated that multiple telecommunication devices 102 can send communication requests 110 to the server 104. Thus, the server 104 may facilitate and initiate mobile chat between multiple telecommunication devices 102 and multiple third party computing devices 105.

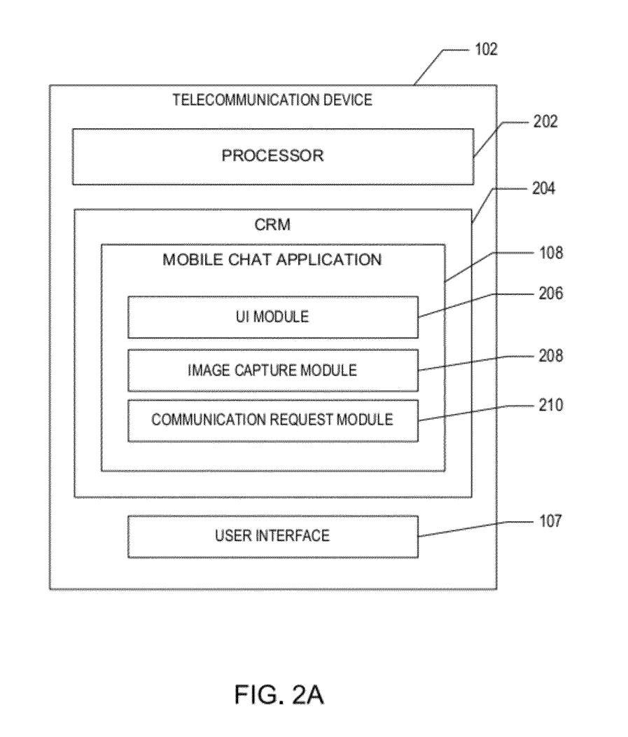

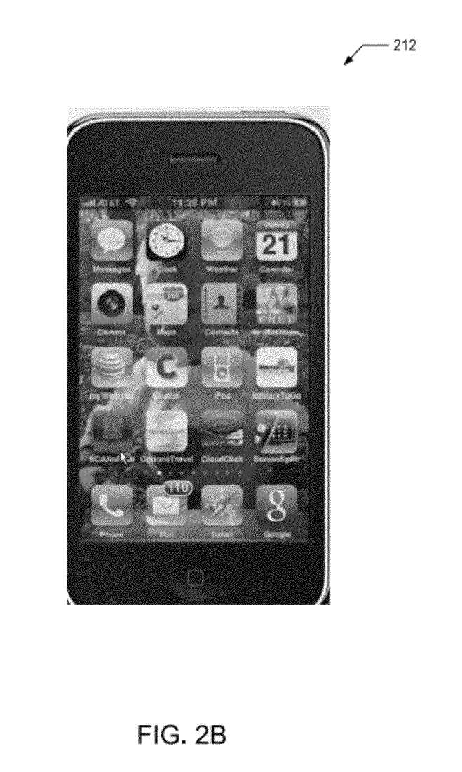

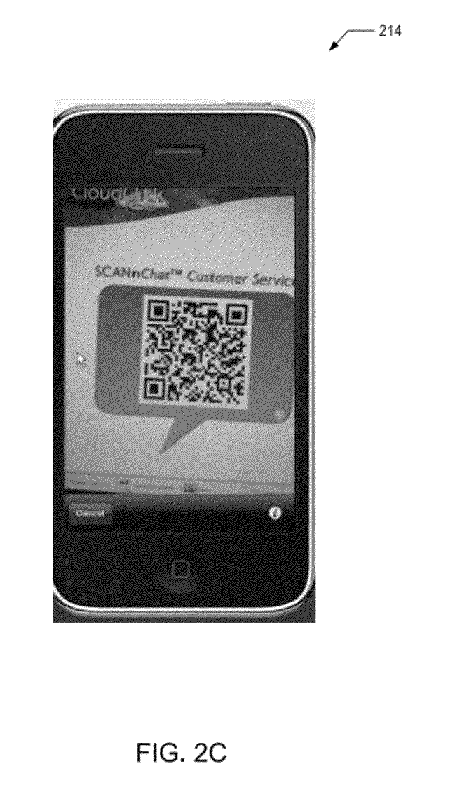

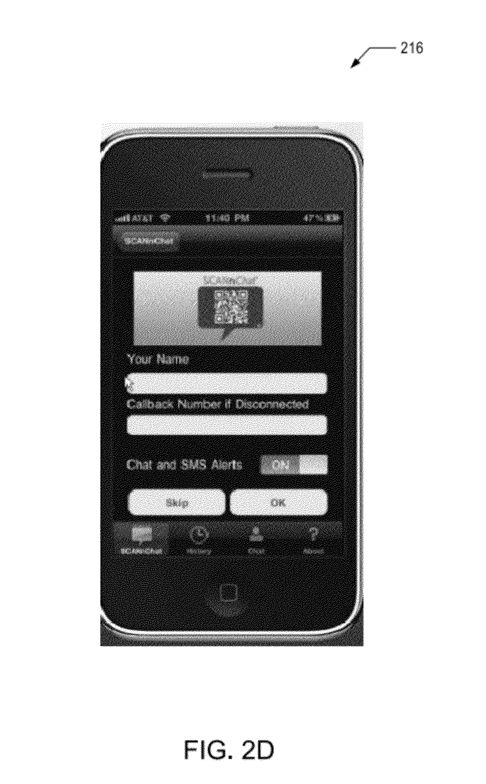

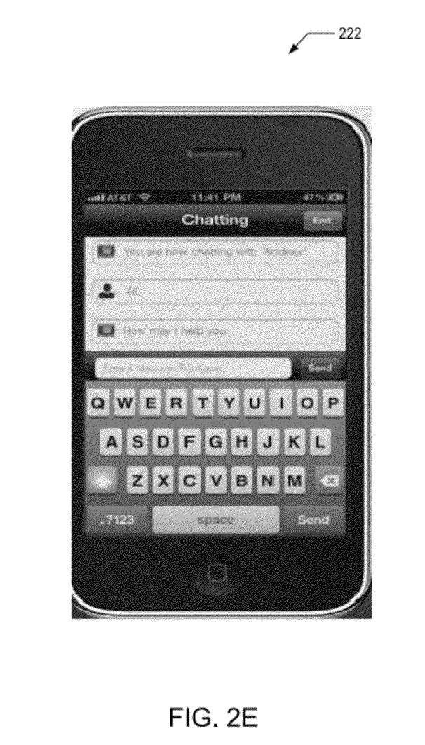

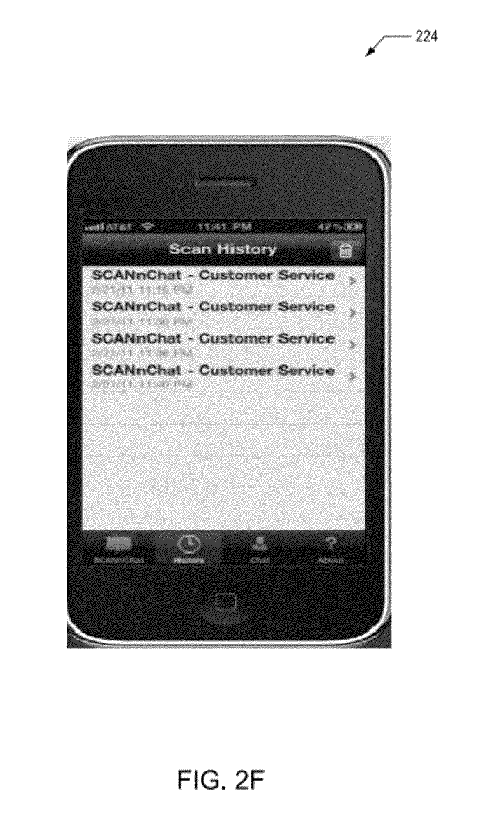

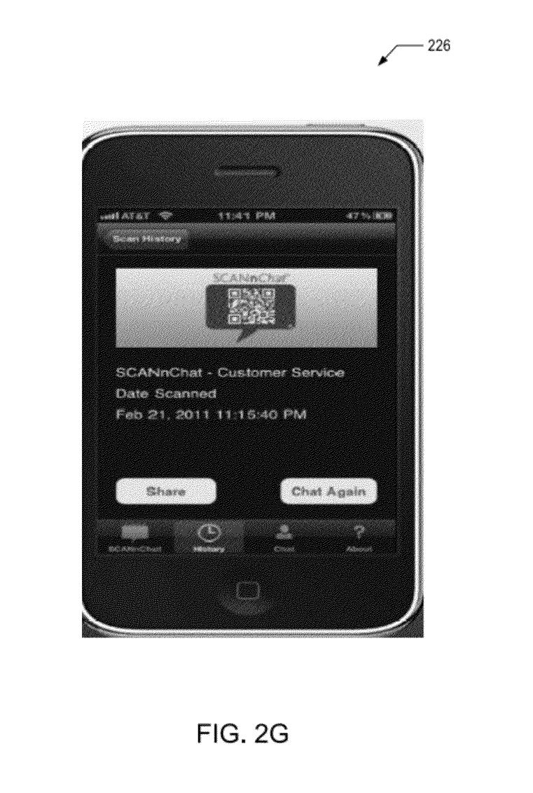

FIG. 2A is a block diagram illustrating a telecommunication device 102. The telecommunication device 102 includes a processor 202 that executes the mobile chat application 108 to enable the user to generate the communication request 110.

According to one aspect, the telecommunication device 102 includes a computer readable medium (“CRM”) 204 configured with the mobile chat application 108. The mobile chat application 108 includes instructions or modules that are executable by the processing system 202 to view, capture, and transmit image data. For example, in one embodiment, the mobile chat application 108 includes a UI module 206, an image capture module 208, and a communication request module 210. Other modules may also be included.

The CRM 204 may include volatile media, nonvolatile media, removable media, non-removable media, and/or another available medium that can be accessed by the telecommunication device 102. By way of example and not limitation, computer readable medium 204 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

The UI module 206 interacts with the user interface 107 of the telecommunication device 102 to display various screens and input forms relating to the mobile chat application 108. Initially, the UI module 206 may display a screen allowing a user to activate the mobile chat application 108 on the telecommunication device 102. For purposes of illustration, an example mobile chat application activation screen is depicted in FIG. 2B.

According to another aspect, the UI module 206 may display a form for capturing image data at the telecommunication device 102. For example, the UI module 206 may respond to interaction with the user interface 107 to display and capture a QR code. For purposes of illustration, an example image capture screen shot is depicted in FIG. 2C.

According to one aspect, the UI module 206 may display a form for receiving contact data related to a particular user of the telecommunication device 102. For example, the UI module 206 may display a form that receives a user's name, phone number, or other contact information. For purposes of illustration, an example screen shot is depicted in FIG. 2D.

According to another aspect, the UI module 206 may display a chat screen for displaying chat communication data between the telecommunication device 102 and the third party computing device 105. For purposes of illustration, an example chat screen is depicted in FIG. 2E.

According to one aspect, the UI module 206 may display a chat history screen for displaying information relating to past chat communications between the telecommunication device 102 and the third party computing device 105. For example, the screen may display past chats that a telecommunication device had with a particular third party computing device. A user may select and engage in a displayed past chat session, or share past chat sessions with a friend. For purposes of illustration, an example chat screen is depicted in FIG. 2F.

According to another aspect, the UI module 206 may display a chat session screen for displaying information relating to a particular chat session between a telecommunication device 102 and a third party computing device 105. For example, the chat session screen may display the date and time stamp of for a particular chat session that occurred between the telecommunication device and the third party computing device and any associated image data captured, such as a QR code. For purposes of illustration, an example chat screen is depicted in FIG. 2G.

The image capture module 208 generates image data in response to the user interacting with telecommunication device 102 to capture an image. For example, a user may capture an image using a camera operatively connected to the telecommunication device 102. In one aspect, the image may be a QR code. As described above, A QR code is a 2D barcode readable by QR code readers and camera phones. Typically, the QR code consists of black modules arranged in a square pattern on a white background. The information encoded can be text, URL, or other data. QR codes may be captured from print media such as news papers, magazines, or other printed publications. Additionally, QR codes may be captured from electronic media, such as facebook. According to one aspect, a QR code may encode information identifying the location of the customer associated with a particular telecommunication device, a product or service associated with QR code, and a particular third party computing device 105 representing customer service, marketing, and/or promotional personnel associated with the identified product or service.

Although the embodiments above describe the image data as a QR code, it is contemplated that any type of image data capable of embedding or encoding information, or capable of being associated with a particular product or service, may be captured by the image capture module 208 and subsequently used to initiate mobile chat between a telecommunication device and a particular third party computing device. For example, the image capture module 208 may download digital image data with encoded chat communication data via the Internet to the telecommunication device 102.

As another example, the image data may be a picture of a landmark, a dress, a golf club, or any other captured image of any object that may be associated with a product or service and third party computing device. According to one aspect, the mobile chat application 112 compares the captured image to template image data stored in a database. The template image data includes, for example, previously captured images and corresponding identification data. By comparing a particular captured image to the template image data, the corresponding identification data can be identified for that particular captured image.

The communication request module 210 is responsive to the UI module 206 and the image capture module 208 to generate and transfer the communication request 110, which comprises the image data, to the server 104. For example, the communication request module may send a captured QR code and any profile data (name, phone number, email address, etc) associated with the QR code to the server 104 via the communication request.

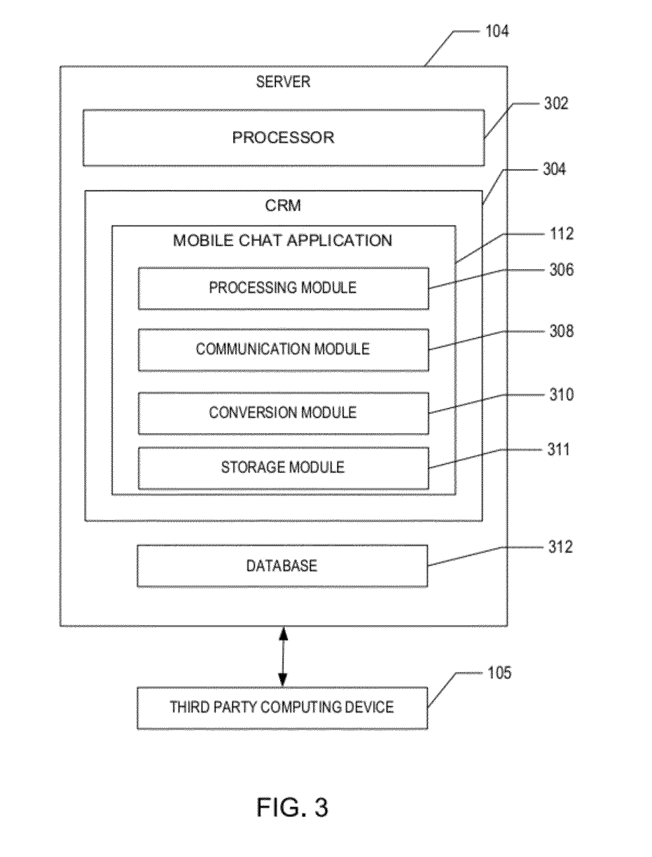

FIG. 3 is a block diagram illustrating the server 104. The server 104 includes a processor 302 that executes the mobile chat application 112 to initiate a communication session between the telecommunication device and a third party computing device in response to received image data.

According to one aspect, the server 104 includes a computer readable media (“CRM”) 304 configured with the mobile chat application 112. The mobile chat application 112 includes instructions or modules that are executable by the processor 302 to process received image data and initiate a communication session between the telecommunication device and with a third party computing device based on the processed image data.

The CRM 304 may include volatile media, nonvolatile media, removable media, non-removable media, and/or another available medium that can be accessed by the server 104. By way of example and not limitation, computer readable medium 304 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

A processing module 306 receives the communication request 110 from the telecommunication device 102. Subsequently, the processing module 306 processes the received communication request 110 to extract the identification data from the captured image data included in the communication request 110. For example, if the captured image were a QR code, the processing module 306 may extract data encoded in the QR code that identifies: a location (e.g., URL) of the third party computing device; a product or service associated with the telecommunication device; and a customer service representative, marketing representative, and/or live person, account manager, or particular account associated with the identified product or service. Other types of communication data connecting a product or service to a third party may also be identified.

According to another aspect, the processing module 306 may query records in a database 312 to identify a product or service associated with an image, and a customer service representative, marketing representative, and/or live person, account manager, or particular account associated with the identified product or service. For example, the database 312 may a general repository of data including but not limited to pre-stored image data, such as a catalog of consumer goods or product images (e.g., golf clubs, clothing, vehicles, etc.), and/or other data capable of being associated with a third party computing device 105. Each record in the database 312 may identify a particular image and identify a location on the communication network of a corresponding third party computing device 105.

In one such aspect, the processing module 306 queries the database 312 for pre-stored image data that matches the image data in the received communication request 110 and, thus, identify the location on the communication network of a corresponding third party computing device 105. The database 312 may include memory and one or more processors or processing systems to receive, process, query and transmit communications and store and retrieve data. In another aspect, the database may be a database server.

A communication module 308 forwards the reference character 116 to the third party computing device 105 based on the location identified by the processing module 306. The communication module 308 then receives a communication response 118 from the third party computing device 105. The communication response 118 may include third party chat communication data.

The third party chat communication data may include messages, text, image data, audio, video, or any other form of communicative data between the telecommunication device 102 and the third party computing device 105. For example, the communication module 308 may receive a communication response 118 comprising text data that describes a product or service identified by the processing module 306. As another example, the communication response 118 may comprise third party chat message data, such as “Would you like to initiate a chat session with a sales representative.”

A conversion module 310 converts the third party chat communication data into a format adapted for viewing and processing on the telecommunication device 102. For example, the conversion module converts the chat communication data from a HTML format received from the third party computing device 105 to a WAP format. The communication module 308 then transmits the converted chat communication data to the telecommunication device 102 in the form of a converted communication response 120.

According to another aspect, the user of the telecommunication device 102 interacts with the user interface 107 to generate a mobile chat communication (not shown). The mobile chat communication may comprise user chat message data, such as “I would like to find out more about Product X.” In this example, the conversion module 310 receives the mobile chat communication from the telecommunication device 102. The conversion module 310 converts the user chat message data into a format adapted for viewing and processing on the third party computing device 105. For example, the conversion module converts the chat communication data from a WAP format received from the telecommunication device to a HTML format.

According to another aspect, the mobile chat application includes a storage module 311 that stores contact data included in a communication request 110. For example, if a particular user uses a contact data entry form, such as form 216 depicted in FIG. 2D, to enter contact data for that particular user, the storage module 311 stores such contact data in the database 312.

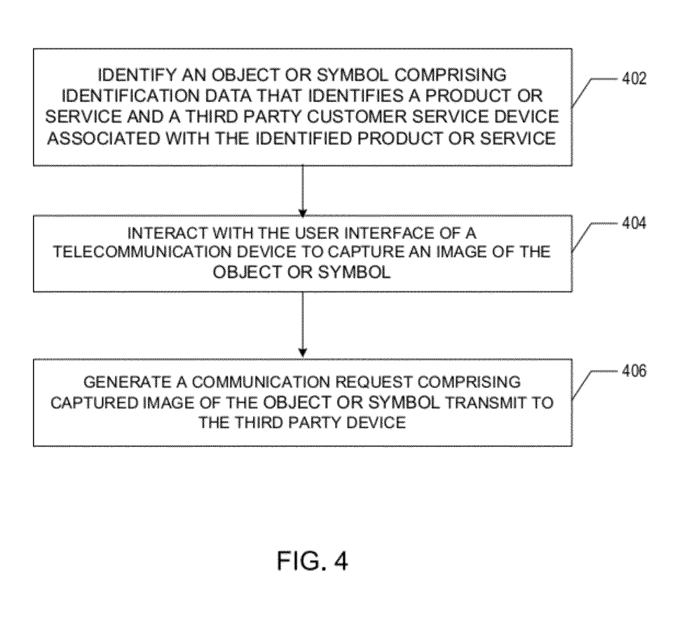

FIG. 4 depicts an example method for generating a communication request at the telecommunication device 102. At 402, a QR code is identified comprising identification data that identifies a particular product or service associated with the QR code and the location of particular third party computing device associated with the particular product or service. A user interacts with the user interface 107 of the telecommunication device 102 to capture an image of the QR code at 404. At 406, the user interacts with the user interface 107 of the telecommunication device 102 to generate a communication request 110 comprising the image of the QR code.

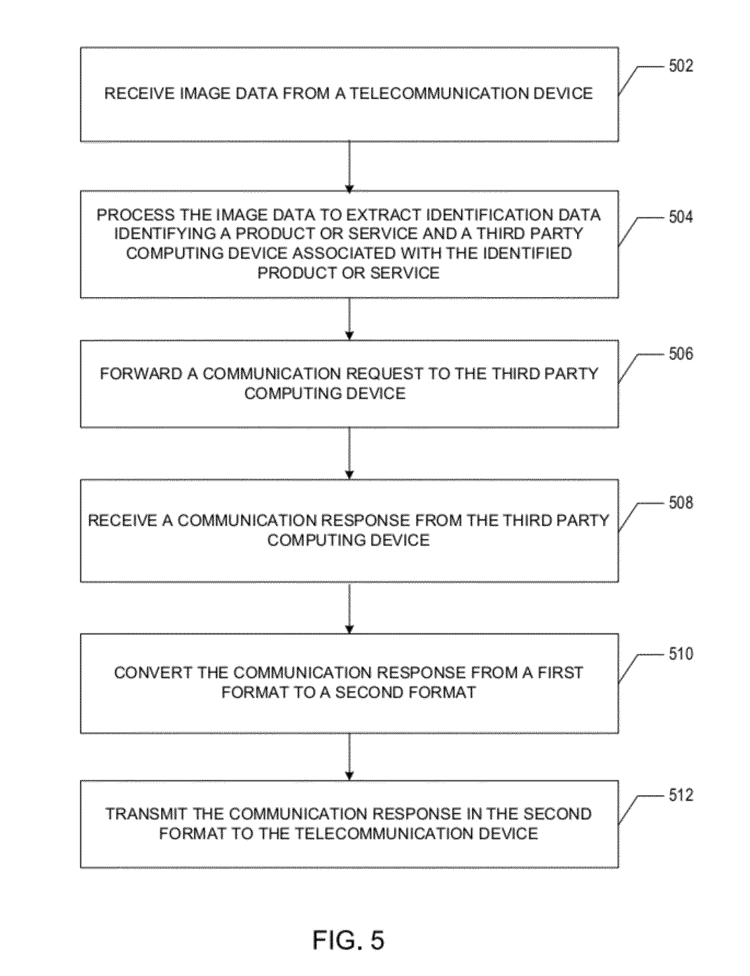

FIG. 5 depicts an example method for enabling mobile chat between a telecommunication device and a third party computing device according to an example embodiment. At 502, a communication request comprising image data is received at the server 104. The image data is processed to extract identification data that identifies a product or service associated with the image data, a third party customer service device, and a location of the third party computing device 105 at 504. At 506, the communication request is forwarded to the third party computing device 105 at the identified location. At 508, a communication response 118 is received from the third party computing device 105. At 510 the communication response 118 is converted from a first format to a second format. The converted communication response is transmitted in the second format to the telecommunication device at 512.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A method for enabling mobile chat comprising:
receiving, at a server, a communication request from a telecommunication device, the communication request comprising image data;
processing, at the server, the image data to extract identification data, the identification data identifying a product or service and a location of a customer service third party computing device on a communication network;
transmitting, at the server, the communication request to the customer service third party computing device based on the identification data;
receiving, at the server, a communication response from the customer service third party computing device, the communication response comprising chat data in a first format;
converting the chat data from the first format to a second format; and
transmitting the chat data in the second format to the telecommunication device.

2. A system for enabling mobile chat comprising:
a server;
a mobile chat application executable by the server to:
receive a communication request comprising image data, the communication request being generated at a telecommunication device;
process the image to extract identification data, the identification data identifying a product or service and a location of a customer service third party computing device on a communication network;
transmit the communication request based on the identification data to the customer service third party computing device;
receive a communication response from the customer service third party computing device, the communication response comprising chat data in a first format; convert the chat data from the first format to a second format; and
transmit the chat data in the second format to the telecommunication device.
